(19) United States
(12) Patent Application Publication
(10) Pub. No.: US 2012/0183109 A1
(43) Pub. Date: Jul. 19, 2012

(54) WORLD DIGITAL RADIO RECEIVER WITH IMAGE SIGNAL REJECTION

(75) Inventors: Chao-Tung Yang, Hsinchu (TW); Chung-Yun Chou, Hsinchu (TW)

(73) Assignee: KeyStone Semiconductor Corp., Hsinchu (TW)

(21) Appl. No.: 13/006,439

(22) Filed: Jan. 14, 2011

(51) Int. Cl. H04B 1/10

(52) U.S. Cl. 375/350; 375/346

(57) ABSTRACT

A broadcast receiver with image rejection is proposed. The broadcast receiver includes a radio frequency processing unit and a baseband processing unit. The radio frequency processing unit receives a first input signal and a second input signal, amplifies the first input signal and the second input signal, down-converts the second input signal, and generating a first signal and a down-converted second signal. Besides, the baseband processing unit receives one of the first signal and the down-converted second signal, filters the received signal thereof, wherein the baseband processing unit comprises an anti-aliasing filter unit which attenuates adjacent channel interference of the received signal, and when the received signal is the down-converted second signal, the anti-aliasing filter unit attenuates a portion of an image signal in the received signal.

### BACKGROUND

1. Technology Field of the Invention

The present invention relates to a world digital radio receiver, and more particularly, to a broadcast receiver with image signal rejection.

2. Description of Related Art

Currently, a portable device such as a mobile phone, a radio player or a multimedia player mostly includes a broadcast receiver which supports multiple broadcast system standards. Due to limited size of the portable device and tight power consumption requirements thereof, the broadcast receiver usually is designed to down-convert multiple radio frequency signals (belonging to broadcast systems of different standards) received on antennas of the broadcast receiver to intermediate frequency signals. However, the down-conversion of the radio frequency signals to the intermediate frequency signals produces the image signals therein unavoidably. In order to filter out the image signals, an image signal rejection filter such as a complex filter is conventionally adopted in a baseband processing stage. Nonetheless, such an approach mainly relies on performance of the image signal rejection filter, and if there is a mismatch in the image signal rejection filter, overall performance of demodulation of broadcast signals is severely influenced. In addition, the conventional approach of adopting just the image signal rejection filter usually may result in higher complexity and cost of circuit design of the image signal rejection filter.

### SUMMARY

According to an exemplary embodiment consistent with the present invention, a broadcast receiver with image signal rejection capability is provided. The broadcast receiver provided by the exemplary embodiment of the present invention utilizes an anti-aliasing filter to attenuate a portion of the image signal of a down-converted signal before the image signal of the down-converted signal is further filtered out by an image signal rejection filter.

According to an exemplary embodiment consistent with the present invention, a broadcast receiver with image rejection is provided. The broadcast receiver includes a radio frequency processing unit and a baseband processing unit. The radio frequency processing unit receives a first input signal and a second input signal, amplifies the first input signal and the second input signal, down-converts the second input signal, and generates a first signal and a down-converted second signal. Besides, the baseband processing unit receives one of the first signal and the down-converted second signal, filters the received signal, wherein the baseband processing unit comprises an anti-aliasing filter unit which attenuates adjacent channel interference of the received signal, and when the received signal is the down-converted second signal, the anti-aliasing filter unit attenuates a portion of an image signal in the received signal.

According to an exemplary embodiment consistent with the present invention, a radio frequency processing unit for a broadcast receiver is also provided, wherein the broadcast receiver includes the radio frequency processing unit and a baseband processing unit. Besides, the radio frequency processing unit includes a first radio frequency amplifier module, a second radio frequency amplifier module, a down-converter unit, and a frequency synthesizer. Moreover, the first radio frequency amplifier module receives a first input signal, amplifies the first input signal and generates a first signal. Further, the second radio frequency amplifier module receives a second input signal and amplifies the second input signal. Also, the down-converter unit, converts the amplified second input signal from a radio frequency signal to an intermediate frequency signal, splits the amplified and converted second input signal into two sub-signals, wherein the two sub-signals are substantially 90 degrees out of phase (i.e. substantially orthogonal to each other) and the two sub-signals form a down-converted second signal. In addition, the frequency synthesizer generates a local oscillation frequency signal and provides the local oscillation frequency signal to the down-converter unit.

According to an exemplary embodiment consistent with the present invention, a baseband processing unit for a broadcast receiver is further provided, wherein the broadcast receiver includes a radio frequency processing unit and the baseband processing unit. Besides, the baseband processing unit receives one of a first signal and a down-converted second signal from the radio frequency processing unit, wherein the down-converted second signal is down-converted from a radio frequency signal and split into two sub-signals in the radio frequency processing unit. Moreover, the baseband processing unit includes an anti-aliasing filter unit and an image signal rejection unit. Also, the anti-aliasing filter unit includes two anti-aliasing filters cross-coupled together which attenuates adjacent channel interference of the received signal, and when the received signal is the down-converted second signal, the anti-aliasing filter unit attenuates a portion of an image signal in the received signal. In addition, when the received signal is the down-converted second signal, the image signal rejection unit rejects a portion of the image signal of the down-converted second signal after being attenuated by the anti-aliasing filter unit.

According to an exemplary embodiment consistent with the present invention, a broadcast receiver with image signal rejection capability is provided. The broadcast receiver provided by the exemplary embodiment of the present invention utilizes the anti-aliasing filter to attenuate a portion of the image signal of the down-converted signal before the image signal of the down-converted signal is further filtered out by an image signal rejection filter. Therefore, the exemplary embodiment of the present invention simplifies circuit complexity, reduces performance requirement, and decreases circuit layout of the image signal rejection filter of the broadcast receiver.

In order to make the features and advantages of the present invention comprehensible, exemplary embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a broadcast receiver according to an exemplary embodiment of the present invention.

FIG. 2 is a block diagram illustrating a radio frequency processing unit according to an exemplary embodiment of the present invention.

FIG. 3 is a block diagram illustrating a baseband processing unit according to an exemplary embodiment of the present invention.

FIG. 4 is a block diagram illustrating an image rejection unit according to an exemplary embodiment of the present invention.

FIG. 5 is a block diagram illustrating an image rejection unit according to another exemplary embodiment of the present invention.

### DESCRIPTION OF EMBODIMENTS

Reference will now be made in detail to the present embodiments of the invention, examples of which are illustrated in the accompanying drawings. Wherever possible, the same reference numbers are used in the drawings and the description to refer to the same or like parts.

The exemplary embodiment of the present invention proposes a broadcast receiver with image signal rejection capability. The broadcast receiver provided by the exemplary embodiment of the present invention utilizes an anti-aliasing filter to attenuate a portion of the image signal of a down-converted signal. In addition, the image signal of the down-converted signal is further filtered out by an image signal rejection filter. The broadcast receiver will be described in details in the following.

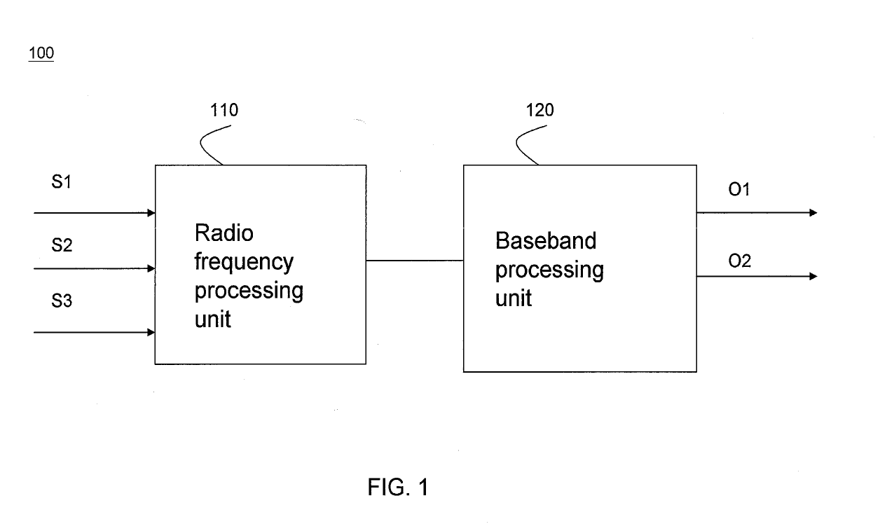

FIG. 1 is a block diagram illustrating a broadcast receiver 100 according to an exemplary embodiment of the present invention. Referring to FIG. 1, in the present exemplary embodiment, the broadcast receiver 100 includes a radio frequency processing unit 110 and a baseband processing unit 120. The radio frequency processing unit 110 is configured to receive a first input signal S1, a second input signal S2, and a third input signal S3. Besides, the radio frequency processing unit 110 is configured to amplify the first input signal S1, the second input signal S2 and the third input signal S3. Also, the radio frequency processing unit 110 is configured to down-convert the second input signal S2 and the third input signal S3, and generating a first signal S1′ (not shown), a down-converted second signal S2′ (not shown) and a down-converted third signal S3′ (not shown). Further, it is to be noted that, the first input signal S1, the second input signal S2 and the third input signal S3 are radio frequency signals of different broadcast system standards. In addition, the first input signal S1, the second input signal S2 and the third input signal S3 are differential signals. It should be understood that, the present invention is not limited thereto, and in other exemplary embodiment of the present invention, the radio frequency processing unit 110 of the broadcast receiver 100 may receive more than three input signals and may also support more than three broadcast system standards.

Referring to FIG. 1, the baseband processing unit 120 is configured to receive one of the first signal S1′, the down-converted second signal S2′ and the down-converted third signal S3′. Besides, the baseband processing unit 120 is configured to receive one of the first signal S1′, the down-converted second signal S2′ and the down-converted third signal S3′, wherein the baseband processing unit 120 includes an anti-aliasing filter unit (not shown) which may attenuate adjacent channel interference of one of the first signal S1′, the down-converted second signal S2′ and the down-converted third signal S3′, and also attenuates a portion of an image signal in one of the down-converted second signal S2′ and the down-converted third signal S3′. In addition, the baseband processing unit 120 generates a first output signal O1, or alternatively, generates the first output signal O1 and a second output signal O2. When the received signal of the baseband processing unit 120 is the first signal S1′, the first output signal O1 is generated according to the first signal S1′. On the other hand, when the received signal of the baseband processing unit 120 is the second signal S2′ or the third signal S3′, both of the first and second output signals O1 and O2 are generated according to the second signal S2′ or the third signal S3′.

Referring to FIG. 1, in the present exemplary embodiment, the first input signal S1 may be, for example, an amplitude modulated signal or a high-definition (HD) radio signal. Besides, the second input signal S2 and the third input signal S3 may be a radio frequency signal such as a frequency modulated signal, a phase modulated signal, a digital audio broadcast signal, a HD radio signal, a digital video broadcast signal, and a digital multimedia broadcast signal. However, as mentioned previously, the second input signal S2 and the third input signal S3 are of different broadcast system standards. In addition to the above-described implementation of the broadcast receiver 100 according to the present exemplary embodiment, a structure of the radio frequency processing unit 110 of the broadcast receiver 100 will be described in the following.

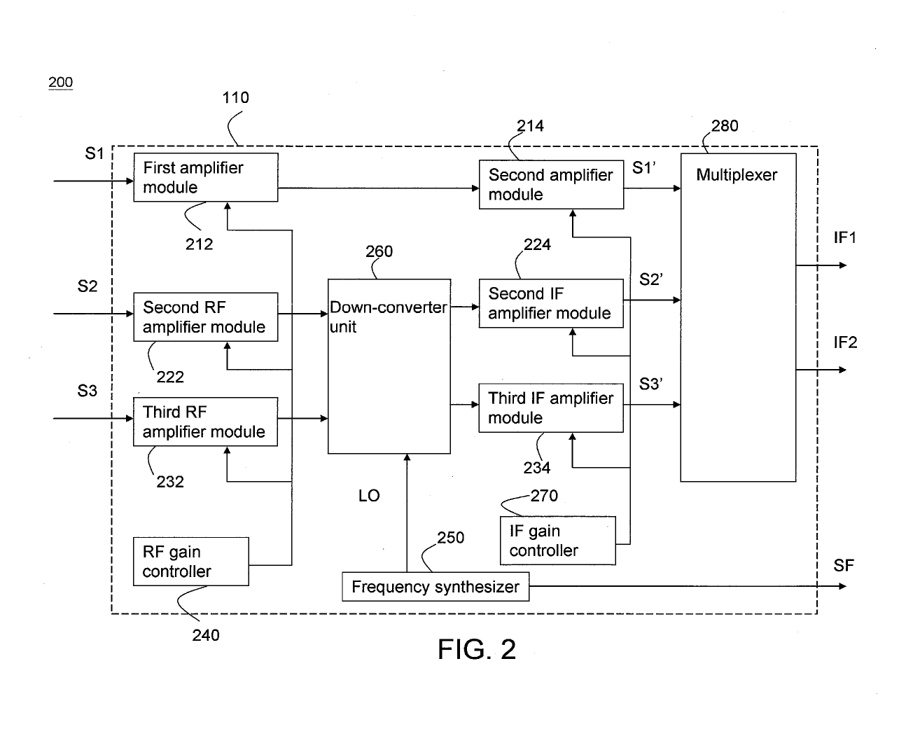

FIG. 2 is a block diagram illustrating the radio frequency processing unit 110 according to an exemplary embodiment of the present invention. Referring to FIG. 2, in the present exemplary embodiment, the radio frequency processing unit 110 includes a first amplifier module 212, a second RF amplifier module 222, a third RF amplifier module 232, a radio frequency (RF) gain controller 240, a frequency synthesizer 250, a down-converter unit 260, a first intermediated frequency (IF) amplifier module 214, a second IF amplifier module 224, a third IF amplifier module 234, an IF gain controller 270, and a multiplexer 280.

Referring to FIG. 2, the first amplifier module 212 is configured to receive the first input signal S1 and amplify the first input signal S1 in a RF band. The second amplifier module 214 is configured to receive the amplified first input signal (not shown), further amplify the amplified first input signal in an IF band, and generate the first signal S1′ to the multiplexer 280. Besides, it should be understood that, the present invention is not limited thereto, and in other exemplary embodiment of the present invention, the first amplifier module 110 and the second amplifier module 214 may be integrated. Furthermore, the amplifying gains of the first amplifier module 110 and the second amplifier module 214 are respectively controlled by the RF gain controller 240 and the IF gain controller 270, and both of the RF gain controller 240 and the IF gain controller 270 are auto-gain controllers.

Referring to FIG. 2, the second RF amplifier module 222 is configured to receive the second input signal S2 and amplify the second input signal S2 in the RF band. Moreover, the down-converter unit 260 is configured to receive an local oscillation frequency signal LO from the frequency synthesizer 250 and convert the amplified second input signal (not shown) from a second RF signal (not shown) to an second IF signal (not shown). The second IF signal includes two sub-signals, wherein the two sub-signals are substantially 90 degrees out of phase. That is, the two sub-signals are respectively I and Q channel signals, and the two sub-signals are substantially orthogonal to each other. Further, the second IF amplifier module 224 is configured to receive the second IF signal, amplify the second IF signal, and output the amplified second IF signal S2′ to the multiplexer 280. In addition, the frequency synthesizer 250 is also configured to generate a sampling frequency signal SF and provide the sampling frequency signal SF to the baseband processing unit 120. Furthermore, amplifying gains of the second RF amplifier module 222 and the second IF amplifier module 224 are respectively controlled by the RF gain controller 240 and the IF gain controller 270.

Referring to FIG. 2, in the present exemplary embodiment, in a similar manner, the third RF amplifier module 232 is configured to receive the third input signal S3 and amplify the third input signal S3. Moreover, the down-converter unit 260 is configured to receive the local oscillation frequency signal LO from the frequency synthesizer 250 and convert the amplified third input signal (not shown) from a third RF signal (not shown) to an third IF signal (not shown). It is to be noted that, since the second input signal S2 and the third input signal S3 are frequency signals of different broadcast system standards, when the down-converter unit 260 performs down conversion of the amplified third input signal, a frequency of the local oscillation frequency LO received by the down-converter unit 260 is different from that in the case where the down-converter unit 260 performs the down conversion of the amplified second input signal. Further, the third IF signal also includes two sub-signals, wherein the two sub-signals are substantially 90 degrees out of phase. In addition, the third IF amplifier module 234 is configured to receive the third IF signal, amplify the third IF signal, and output the amplified third IF signal S3′ to the multiplexer 280. Furthermore, amplifying gains of the third RF amplifier module 232 and the third IF amplifier module 234 is respectively controlled by the RF gain controller 240 and the IF gain controller 270.

Referring to FIG. 2, in the present exemplary embodiment, the frequency synthesizer 250 is capable of adjusting a frequency of the local oscillation frequency signal LO according to which broadcast system standard the second input signal S2 or the third input signal S3 belongs to. For example, if the second input signal S2 received by the second RF amplifier module 222 is determined as the frequency modulated signal which is modulated at a lower frequency band, the frequency synthesizer 250 may provide the local oscillation frequency signal LO with the a lower frequency to the down converter unit 260. On the other hand, for another example, if the third input signal S3 received by the third RF amplifier module 232 is determined as the digital audio broadcast signal which is modulated at much higher frequency band than the frequency modulated signal, the frequency synthesizer 250 may provide the local oscillation frequency signal with a higher frequency to the down converter unit 260. Accordingly, power consumption of the broadcast receiver may be intelligently preserved by adjusting the frequency of the local oscillation frequency signal LO according to the broadcast system standard to which the second input signal S2 or the third signal S3 belongs.

Referring to FIG. 2, in the present exemplary embodiment, the multiplexer 280 of the radio frequency processing unit 110 multiplexes the first signal S1′, the second IF signal S2′ and the third IF signal S3′, and outputs two signals IF1 and IF2 to the baseband processing unit 120. The signal IF 1 may include just the first signal S1′ and the signal IF2 does not contain anything if an operation mode of the broadcast receiver 100 selected by a user is just for processing the first input signal S1. On the other hand, the signal IF1 and the signal IF2 may respectively include the two sub-signals of the second IF signal S2′ if the operation mode of the broadcast receiver 100 selected by a user is for processing the second input signal S2. Similarly, the signal IF1 and the signal IF2 may respectively include the two sub-signals of the third IF signal S3′ if the operation mode of the broadcast receiver 100 selected by a user is for processing the third input signal S3. In addition, the signal IF1 and the signal IF2 provided from the multiplexer 280 to the baseband processing unit 120 may also be differential signals.

Besides, in the present exemplary embodiment, the frequency synthesizer may be implemented by a phase-locked loop. Moreover, the frequency synthesizer 250 may also provide the baseband processing unit 120 with the sampling frequency SF with a preset sampling frequency. In particular, the frequency synthesizer 250 provides at least an analog-to-digital converter (ADC) (not shown) of the baseband processing unit 120 with the sampling frequency SF with the preset sampling frequency. Further, the frequency synthesizer 250 may adjust the sampling frequency of the sampling frequency SF such that a sampling rate of the ADC may be adjusted according to the RF signals or the IF signals being processed in the ADC. For example, if the RF signal being processed in the ADC is an amplitude modulated signal or a HD radio signal, the frequency synthesizer 250 may provide the ADC with the oscillation signal with a low sampling frequency. On the other hand, for another example, if the IF signals being processed in the ADC is the digital audio broadcast signal, then the frequency synthesizer 250 may provide the ADC with the oscillation signal with a higher sampling frequency. In addition to the above-described implementation of frequency synthesizer 250, the sampling frequency SF provided to the baseband processing unit 120 may also adjusted by a frequency divider (not shown) and further provided to the ADC in the baseband processing unit 120, wherein the frequency divider may also be embedded in the baseband processing unit 120.

In addition to the above-described implementation of the radio frequency processing unit 110 according to the present exemplary embodiment, a structure of the baseband processing unit 120 of the broadcast receiver 100 will be described in details in the following.

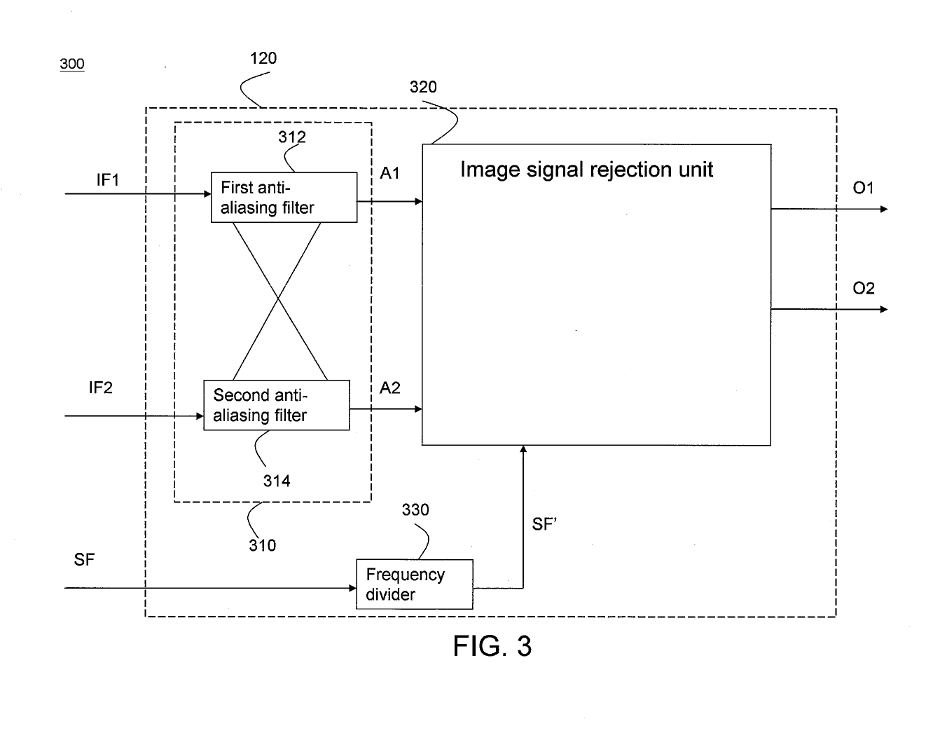

FIG. 3 is a block diagram illustrating the baseband processing unit 120 according to an exemplary embodiment of the present invention. Referring to FIG. 3, in the present exemplary embodiment, the baseband processing unit 120 includes an anti-aliasing filter unit 310, an image signal rejection unit 320 and a frequency divider 330. The anti-aliasing filter unit 310 includes a first anti-aliasing filter 312 and a second anti-aliasing filter 314, which are cross-coupled together to co-operate as a complex anti-aliasing filter. Besides, the first anti-aliasing filter 312 and a second anti-aliasing filter 314 are configured to receive the signal IF1 and the signal IF2, wherein the signal IF1 and the signal IF2 are output from the multiplexer 280 of FIG. 2. Moreover, the image signal rejection unit 320 is configured to reject a portion of the image signal of the two attenuated sub-signals A1 and A2 after the signal IF1 and the signal IF2 are attenuated by the anti-aliasing filter unit 310.

Referring to FIG. 1 and FIG. 3, as mentioned previously, the first anti-aliasing filter 312 and the second anti-aliasing filter 314 of the anti-aliasing filter unit 310 are configured to attenuate the adjacent channel interference of one of the first signal S1′, the second IF signal S2′ and the third IF signal S3′, wherein the second IF signal S2′ is a down-converted signal from the second input signal S2, and the S3′ is a down-converted signal from the third input signal S3. Besides, the first anti-aliasing filter 312 and the second anti-aliasing filter 314 also configured to altogether attenuate a portion of an image signal in the second IF signal S2′ or a portion of an image signal in the third IF signal S3′. In particular, just either the first anti-aliasing filter 312 or the second anti-aliasing filter 314 is required to perform attenuating the adjacent channel interference of the first signal S1′ since the first signal S1′ is not down-converted in the radio frequency processing unit 110. Besides, the first anti-aliasing filter 312 and the second anti-aliasing filter 314 are analog filters and are also configured to respectively process the radio frequency signal or the intermediate frequency signal in a fashion of real number. Further, since the first anti-aliasing filter 312 and the second anti-aliasing filter 314 are cross-coupled together, the anti-aliasing filter unit 310 may provide a complex-filtering to the second IF signal S2′ and the third IF signal S3′.

Referring to and FIG. 3, the frequency divider 330 is configured to receive the sampling frequency signal SF from the frequency synthesizer 250, convert the sampling frequency signal SF to the converted sampling frequency signal SF′, and output the converted sampling frequency signal SF′ to the image signal rejection unit 320 according to the operation mode selected by the user. In particular, the converted sampling frequency signal SF′ output from to the image signal rejection unit 320 may be provided to the ADC (not shown) in the image signal rejection unit 320. In addition to the above-described implementation of the baseband processing unit 120 according to the exemplary embodiment, the image rejection unit 320 of the baseband processing unit 120 may be an ADC module with image signal rejection capability, or may include an ADC module and an image signal rejection filter module, and the image rejection unit 320 will be described in details in the following.

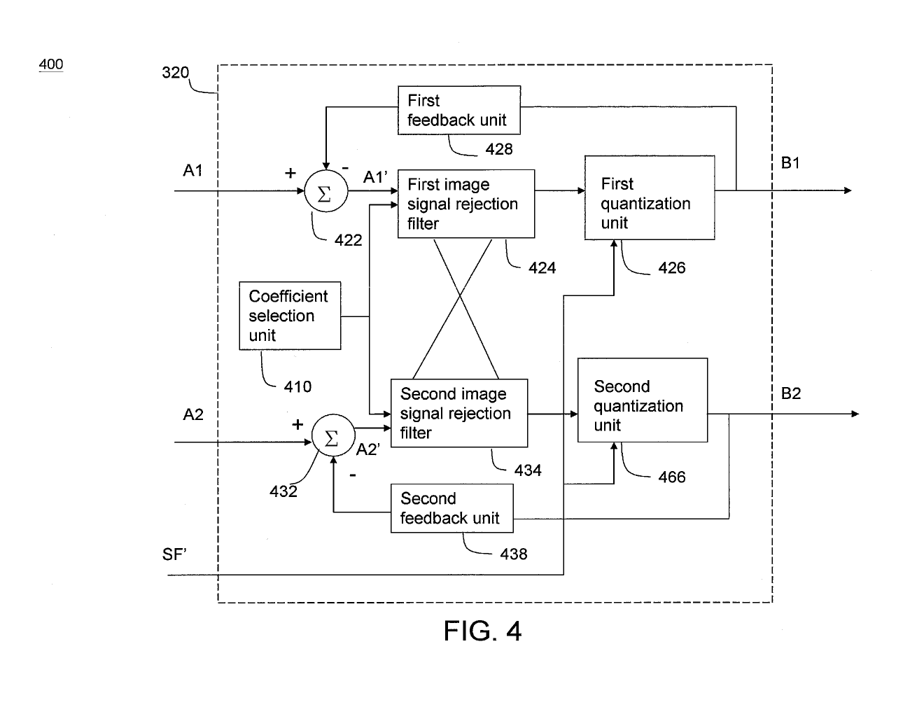

FIG. 4 is a block diagram illustrating the image rejection unit 320 according to an exemplary embodiment of the present invention. The image rejection unit 320 in this exemplary embodiment is an ADC module with the image signal rejection capability. The image signal rejection unit 320 includes a first image signal rejection filter 424, a second image signal rejection filter 434, a first quantization unit 426, a second quantization unit 436, a first feedback unit 428, a second feedback unit 438, a first summation unit 422, a second summation unit 432, and a coefficient selection unit 410.

Referring to FIG. 4, the first image signal rejection filter 424 and the second image signal rejection filter 434 are analog filters and cross-coupled together to co-operate as a complex image signal filter to provide complex filtering to a subtracted sub-signal A1′ and a subtracted sub-signal A2′, where the subtracted sub-signals A1′ and A2′ are respectively generated from the sub-signals A1 and A2. Besides, in the present exemplary embodiment, the first image signal rejection filter 424 and the second image signal rejection filter 434 may be implemented by continuous time switch-capacitor complex filters with an M-order, wherein M is a positive integer. The first quantization unit 426 and the second quantization unit 436 are respectively coupled to the image signal rejection filters 424, 434, and are respectively coupled to the frequency divider 330 for receiving the converted sampling frequency signal SF′.

Moreover, the first quantization unit 426 and the second quantization unit 436 respectively generate output sub-signals B1, B2 according to the sub-signals A1 and A2. The first feedback unit 428 and the second feedback unit 438 are respectively coupled to the first quantization unit 426 and the second quantization unit 436. The first summation unit 422 and the second summation unit 432 are respectively configured to subtract an analog feedback signal from one of the sub-signals A1, A2, respectively coupled to the anti-aliasing filter unit 310, and configured to provide the subtracted sub-signals A1′, A2′ to the first image signal rejection filter 424 and the second image signal rejection filter 434.

In addition, the coefficient selection unit 410 is electrically coupled to the image signal rejection filters 424, 434, and configured to select appropriate coefficients for the image signal rejection filters 424, 434 according to the broadcast system standard to which the AM input signal, the FM input signal or the DAB input signal respectively belongs.

In addition to the above-described implementation of the image rejection unit 320 as illustrated in FIG. 4, the image rejection unit 320 may also be implemented with the ADC module and digital image signal rejection filter module. A structure of such an implementation of the image rejection unit 320 will be described in details in the following.

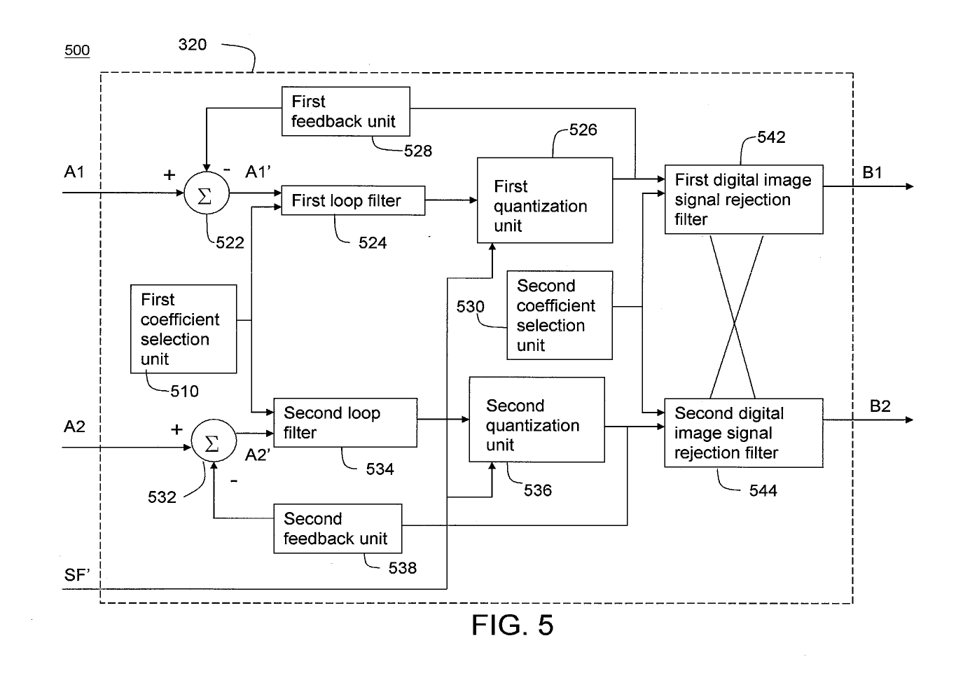

FIG. 5 is a block diagram illustrating the image rejection unit 320 according to another exemplary embodiment of the present invention. Referring to FIG. 5, in the present exemplary embodiment, the image rejection unit 320 may include the ADC module and a digital image signal rejection filter module (not shown). In particular, the ADC module may include a first loop filter 524, a second loop filter 534, a first quantization unit 526, a second quantization unit 536, a first feedback unit 528, a second feedback unit 538, a first summation unit 522, a second summation unit 532, and a first coefficient selection unit 510.

Besides, the digital image signal rejection filter module may include a second coefficient selection unit 530, a first digital image signal rejection filter 542, and a second digital image signal rejection filter 544. The first digital image signal rejection filter 542 and the second digital image signal rejection filter 544 may be cross-coupled together and implemented by complex filtering algorithms in a digital signal processing (DSP) chip or by digital electronic circuits.

Referring to FIG. 5, the first loop filter 524 and the second loop filter 534 are configured to respectively filter the subtracted sub-signal A1′ and the subtracted sub-signal A2′. In the present exemplary embodiment, the first loop filter 524 and the second loop filter 534 are digital filters, where M is a positive integer. The first quantization unit 526 is coupled to the first loop filter 524 and the first digital image signal rejection filter 542, and the second quantization unit 536 is coupled to the second loop filter 534 and the image signal rejection filter 544.

Moreover, the first quantization unit 526 is coupled to the first feedback unit 528 and the first digital image signal rejection filter 542. The second quantization unit 536 is coupled to the second feedback unit 538 and the second digital image signal rejection filter 544.

Referring to FIG. 5, in the present exemplary embodiment, the summation unit 522 and the summation unit 532 is respectively coupled to the first feedback unit 528 and the second feedback unit 538 and also coupled to the first loop filter 524 and the second loop filter 534. The first digital image signal rejection filter 542 and the second digital image signal rejection filter 544 a are respectively configured to generate the output sub-signal B1 and the output sub-signal B2 corresponding to the subtracted sub-signal A1′ and subtracted sub-signal A2′. Accordingly, the baseband processing unit 120 may generate the first output signal O1 and the second output signal O2 from the output sub-signal B1 and the output sub-signal B2 corresponding to the first input signal S1, the second input signal S2 or the third input signal S3.

Referring to FIG. 5, in the present exemplary embodiment, the first coefficient selection unit 510 and the second coefficient selection unit 530 are configured to determine and select appropriate coefficients according to the determined broadcast system standard to which the first input signal S1, the second input signal S2 or the third input signal S3 respectively belong. In addition, the first coefficient selection unit 510 and the second coefficient selection unit 530 are respectively configured to provide the selected coefficients to the first image signal rejection filter 542, the second image signal rejection filter 544, the first loop filter 524, and the second loop filter 534.

In summary, present invention provides a broadcast receiver with image signal rejection capability. The above-described exemplary embodiments of the present invention utilizes the anti-aliasing filter to attenuate a portion of the image signal of the down-converted signal before the image signal of the down-converted signal is further filtered out by an image signal rejection filter. Besides, the local oscillation frequency of the down-converter unit may be intelligently adjusted according to the radio frequency signals being down-converted. Moreover, the sampling rate of the ADCs of the baseband processing unit may also be intelligently adjusted according to the radio frequency signals or the intermediate frequency signals being sampled. Therefore, the exemplary embodiment of the present invention simplifies circuit complexity, reduces performance requirement, decreases circuit layout of the image signal rejection filter, and lowers power consumption of the broadcast receiver.

Although the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A broadcast receiver with image signal rejection, comprising:
a radio frequency processing unit, receiving a first input signal and a second input signal, amplifying the first input signal and the second input signal, down-converting the second input signal, and generating a first signal and a down-converted second signal; and
a baseband processing unit, receiving one of the first signal and the down-converted second signal, filtering the first signal and the down-converted second signal, wherein the baseband processing unit comprises an anti-aliasing filter unit which attenuates adjacent channel interference of the received signal, and when the received signal is the down-converted second signal, the anti-aliasing filter unit attenuates a portion of an image signal in the received signal.

2. The broadcast receiver as claimed in claim 1, wherein the radio frequency processing unit comprising:
a first amplifier module, receiving the first input signal, amplifying the first input signal and generating the first signal;
a second RF amplifier module, receiving the second input signal and amplifying the second input signal;
a down-converter unit, converting the amplified second input signal from a radio frequency signal to an intermediate frequency signal, splitting the amplified and converted second input signal into two sub-signals, wherein the two sub-signals are substantially 90 degrees out of phase, and the two sub-signals form a down-converted second signal; and
a frequency synthesizer, generating a local oscillation frequency signal and providing the local oscillation frequency signal to the down-converter unit and a sampling frequency to the baseband processing unit.

3. The broadcast receiver as claimed in claim 2, wherein the baseband processing unit further comprising:
the anti-aliasing filter unit, wherein the anti-aliasing filter unit comprises two anti-aliasing filters cross-coupled together, attenuating adjacent channel interference of the received signal, and the received signal is the first signal or comprises the sub-signals, and when the received signal comprises the sub-signals, the anti-aliasing filter unit attenuates a portion of an image signal in the sub-signals; and
an image signal rejection unit, when the received signal comprises the sub-signals, the image signal rejection unit rejects a portion of the image signal of the two sub-signals after the two sub-signals are attenuated by the anti-aliasing filter unit.

4. The broadcast receiver as claimed in claim 3, wherein the image signal rejection unit is an analog-to-digital converter module with image signal rejection capability.

5. The broadcast receiver as claimed in claim 4, wherein the analog-to-digital converter module with the image signal rejection capability comprising:
two summation units, wherein each of the summation units subtracts one of analog feedback signals from one of the sub-signals, so as to generate one of two subtracted signals;
two image signal rejection filters, cross-coupled together, providing complex filtering to the two subtracted signals, wherein each of the image signal rejection filters is coupled to one of the summation units;
two quantization units, wherein each of the quantization units is coupled to one of the image signal rejection filters, quantizing each of the filtered subtracted signals to a digital code;
two feedback units, wherein each of the feedback units receives the digital code and provides one of the two summation units with an analog feedback signal corresponding to the received digital code; and
a coefficient selection unit, comprising coefficients for multiple broadcast system standards, determining which broadcast system standard the first input signal or the second input signal respectively belong to, and selecting appropriate coefficients for the image signal rejection filters according to the determined broadcast system standard the first input signal or the second input signal respectively belong to.

6. The broadcast receiver as claimed in claim 3, wherein the image signal rejection unit comprises an analog-to-digital converter module and a digital image signal rejection module.

7. The broadcast receiver as claimed in claim 6, wherein the analog-to-digital converter module comprising:
two summation units, wherein each of the summation units subtracts one of analog feedback signals from one of the sub-signals, so as to generate one of two subtracted signals;
two loop filters, wherein each of the loop filters is coupled to the one of the summation units, and each of the subtracted signals of the down-converted second signal is filtered by one of the loop filters;
two quantization units, wherein each of the quantization units is coupled to one of the loop filters, and quantizes one of the filtered subtracted signals to a digital code;
two feedback units, wherein each of the feedback units receives the digital code and provides one of the loop filters with an analog feedback signal corresponding to the received digital code; and
two coefficient selection units, wherein each of the coefficient selection units comprises coefficients for multiple broadcast system standards, determining which broadcast system standard the first input signal or the second input signal respectively belong to, selecting appropriate coefficients according to the determined broadcast system standard to which the first input signal or the second input signal respectively belong, and providing the selected coefficients to the loop filters and the digital image signal rejection filter module.

8. The broadcast receiver as claimed in claim 7, wherein the digital image signal rejection filter module comprising:
two digital image signal rejection filter, filtering out a portion of the image signals of the digital code.

9. The broadcast receiver as claimed in claim 1, wherein the first input signal is one of the radio frequency signals selected from the group consisting of an amplitude modulated signal, and a HD radio signal.

10. The broadcast receiver as claimed in claim 2, wherein the frequency synthesizer is capable of adjusting a frequency of the local oscillation frequency signal according to which broadcast system standard the second input signal belongs to.

11. The broadcast receiver as claimed in claim 2, wherein the second input signal is one of the radio frequency signals selected from the group consisting of a frequency modulated signal, a phase modulated signal, a digital audio broadcast signal, a HD radio signal, a digital video broadcast signal, and a digital multimedia broadcast signal.

12. The broadcast receiver as claimed in claim 8, wherein the image signal rejection filters are analog filters.

13. The broadcast receiver as claimed in claim 7, wherein the loop filters are M-order real number loop filters, and the digital image signal rejection filters are digital filters, wherein M is a positive integer.

14. A radio frequency processing unit for a broadcast receiver, wherein the broadcast receiver comprises the radio processing unit and a baseband processing unit, the radio frequency processing unit comprising:
a first amplifier module, receiving a first input signal, amplifying the first input signal and generating a first signal;
a second RF amplifier module, receiving a second input signal and amplifying the second input signal;
a down-converter unit, converting the amplified second input signal from a radio frequency signal to an intermediate frequency signal, splitting the amplified and converted second input signal into two sub-signals, wherein the two sub-signals are substantially 90 degrees out of phase and the two sub-signals form a down-converted second signal; and
a frequency synthesizer, generating a local oscillation frequency signal and providing the local oscillation frequency signal to the down-converter unit.

15. The radio frequency processing unit as claimed in claim 14, wherein the frequency synthesizer is capable of adjusting a frequency of the local oscillation frequency signal according to which broadcast system standard the second input signal belongs to.

16. The radio frequency processing unit as claimed in claim 14, wherein the second input signal is one of radio frequency signals selected from the group consisting of a frequency modulated signal, a phase modulated signal, a digital audio broadcast signal, a HD radio signal, a digital video broadcast signal, and a digital multimedia broadcast signal.

17. The radio frequency processing unit as claimed in claim 14, wherein the first input signal is one of the radio frequency signals selected from the group consisting of an amplitude modulated signal, and a HD radio signal.

18. A baseband processing unit for a broadcast receiver, wherein the broadcast receiver comprises a radio frequency processing unit and the baseband processing unit, and the baseband processing unit receives one of a first signal and a down-converted second signal from the radio frequency processing unit, wherein the down-converted second signal is down-converted from a radio frequency signal and split into two sub-signals in the radio frequency processing unit, the baseband processing unit comprising:
an anti-aliasing filter unit, comprising two anti-aliasing filters cross-coupled together, attenuating adjacent channel interference of the received signal, and the received signal is the first signal or comprises the two sub-signals, and when the received signal comprises the sub-signals, the anti-aliasing filter unit attenuates a portion of an image signal in the down-converted second signal; and
an image signal rejection unit, when the received signal comprises the two sub-signals, the image signal rejection unit rejects a portion of the image signal of the two sub-signals after the two sub-signals are attenuated by the anti-aliasing filter unit.

19. The baseband processing unit as claimed in claim 18, wherein the image signal rejection unit is an analog-to-digital conversion module with image signal rejection capability.

20. The baseband processing unit as claimed in claim 19, the analog-to-digital conversion module with the image signal rejection capability comprising:
two summation units, wherein each of the summation units subtracts one of analog feedback signals from one of the sub-signals, so as to generate one of two subtracted signals;
two image signal rejection filters, cross-coupled together, providing complex filtering to the two subtracted signals, wherein each of the image signal rejection filters is coupled to one of the summation units;
two quantization units, wherein each of the quantization units is coupled to one of the image signal rejection filters, quantizing each of the filtered subtracted signals to a digital code;
two feedback units, wherein each of the feedback units receives the digital code and provides one of the two summation units with an analog feedback signal corresponding to the received digital code; and
a coefficient selection unit, comprising coefficients for multiple broadcast system standards, determining which broadcast system standard the first input signal or the second input signal respectively belong to, and selecting appropriate coefficients for the image signal rejection filters according to the determined broadcast system standard the first input signal or the second input signal respectively belong to.

21. The baseband processing unit as claimed in claim 18, wherein the image signal rejection unit comprises an analog-to-digital converter module and a digital image signal rejection module.

22. The baseband processing unit as claimed in claim 21, wherein the analog-to-digital converter module comprising:
two summation units, wherein each of the summation units subtracts one of analog feedback signals and from one of the sub-signals, so as to generate one of two subtracted signals;
two loop filters, wherein each of the loop filters is coupled to the one of the summation units, and each of the subtracted signals of the down-converted second signal is filtered by one of the loop filters;
two quantization units, wherein each of the quantization units is coupled to one of the loop filters, and quantizes one of the filtered subtracted signals to a digital code; and
two feedback units, wherein each of the feedback units receives the digital code and provides one of the loop filters with an analog feedback signal corresponding to the received digital code; and
two coefficient selection units, wherein each of the coefficient selection units comprises coefficients for multiple broadcast system standards, determining which broadcast system standard the first input signal or the second input signal respectively belong to, selecting appropriate coefficients according to the determined broadcast system standard to which the first input signal or the second input signal respectively belong, and providing the selected coefficients to the loop filters and the digital image signal rejection filter module.

23. The baseband processing unit as claimed in claim 21, wherein the digital image signal rejection filter module comprising:
two digital image signal rejection filters, filtering out a portion of the image signals of the digital code.

24. The baseband processing unit as claimed in claim 18, wherein the first input signal is one of the radio frequency signals selected from the group consisting of an amplitude modulated signal, and a HD radio signal.

25. The baseband processing unit as claimed in claim 18, wherein the second input signal is one of radio frequency signals selected from the group consisting of a frequency modulated signal, a phase modulated signal, a digital audio broadcast signal, a HD radio signal, a digital video broadcast signal, and a digital multimedia broadcast signal.

26. The baseband processing unit as claimed in claim 20, wherein the image signal rejection filters are analog filters.

27. The baseband processing unit as claimed in claim 23, wherein the loop filters are analog filters, and the digital image signal rejection filters are digital filters.
